(19) United States
(12) Patent Application Publication
(10) Pub. No.: US 2004/0067331 A1
(43) Pub. Date: Apr. 8, 2004

(54) Biodegradable tear-off strips and packaging material having said tear-off strips

(76) Inventors: Christian Kuckertz, Olpe (DE); Sven Jacobsen, Fallingbostel (DE); Rainer Brandt, Walsrode (DE)

Correspondence Address: Norris McLaughlin & Marcus, 30th Floor, 220 East 42nd Street, New York, NY, 10017, US

(21) Appl. No.: 10/415,617

(22) PCT Filed: Nov. 2, 2001
(86) PCT No.: PCT/EP01/12678

(30) Foreign Application Priority Data
Nov. 2, 2000 (DE) 100 54 277.8

(51) Int. Cl. B32B 33/00; B32B 9/00

(52) U.S. Cl. 428/41.8; 428/41.7

(57) ABSTRACT

Biodegradable tear-off strips for biodegradable packaging materials, comprising a monoaxially oriented biodegradable aliphatic polyester and/or copolyester.

The present invention relates to tear-off strips whose underlying backing film is biodegradable, as are layers applied thereto. The tear-off strips of the invention may preferably be used in combination with biodegradable packaging materials.

Tear-off strips are generally used as an aid to opening food packagings and consumer goods. Examples which may be mentioned are tobacco products, confectionery, storage media, such as compact disks or music cassettes, bottle hoods, or pharmaceutical packaging. Typical packaging materials which have a tear-off strip to assist opening are wrapper films based on biaxially oriented polypropylene (BOPP), polyester (PET), cellophane, or paper, and also tubular-bag packaging or vacuum packaging.

The products mainly used as tear-off strips are the following:

hot-melt-coated, heat-activatable tear-off strips; self-adhesive tear-off strips, and also tear-off strips with a polyolefin sealable layer, preferably for vacuum packaging.

The application has been considerably facilitated by the use of self-adhesive tear-off strips, since there is no need for additional heating equipment and assemblies for applying the material. Light application pressure is sufficient to achieve an adequately high level of adhesion to the packaging material (U.S. Pat. Nos. 4,887,714, 4,844,962). A 100% level of adhesion is achieved to all types of wrapper film, so that it is impossible to pull the tear-off strip away from the packaging without opening the packaging. In addition, self-adhesive tear-off strips have high visible quality and transparency. Almost all self-adhesive tear-off strips are based on monoaxially oriented polypropylene, its ultimate tensile strength being sufficiently high to ensure reliable use, including use on modern high-performance packaging machinery, such as that used in the cigarette industry.

The structure of these self-adhesive tear-off strips is as follows: one surface of the polypropylene film has a silicone coating, to provide the specific release properties needed. The other surface is provided with a pressure-sensitive adhesive. The two coatings have to be correctly matched to one another to ensure that the tear-off strip can always be easily and uniformly released from the reel. A printed image may optionally be applied below the adhesive coating or silicone coating during the production process.

The tear-off strip is produced from wide film webs. Once the various coatings have been applied, the material is slit to the desired width of the tear-off strips, mostly from 1.6 to 2.5 mm, and reeled.

Despite attempts to design ever thinner packaging materials and thus save valuable raw materials, there has nevertheless been a yearly rise hitherto in packaging volume. Although much of the packaging is collected and then recycled, a considerable amount of packaging, in particular small-scale and very small-scale packaging, such as confectionery packaging or packaging for tobacco products, is assigned to what is known as unclassified waste, or in many instances thoughtlessly discarded.

The use of biodegradable packaging materials would be particularly desirable for this type of packaging.

Many different raw materials are biodegradable under composting conditions. Both blown and flat films are produced from many of these materials. By way of example, there follows a list of some raw materials which can be used to produce films: starch-filled polycaprolactone (WO098/20073), aliphatic polyester-amides (DE 19 753 534 A1, DE 19 800 698 A1, EP 0 820 698 A1), aliphatic and aromatic polyester-urethanes (DE 19822979), polyhydroxyalkanoates (polyhydroxybutyrates, polyhydroxyvalerates), casein (DE 4 309 528), polylactides, and copolylactides (EP 0 980 894 A1).

However, the use of these biodegradable raw materials has hitherto only produced products whose mechanical properties are inadequate for the production of tear-off strips. The production of packaging materials or packaging which is practically fully biodegradable, however, also requires biodegradable tear-off strips.

An object was therefore to provide practically fully biodegradable tear-off strips, so as to obtain fully biodegradable packaging, without having to omit the convenience of an aid to opening.

According to the invention, this has been achieved by providing tear-off strips whose production used film material made from selected biodegradable raw materials, from biodegradable adhesives, and, where appropriate, printing inks.

The invention therefore provides a biodegradable tear-off strip made from a backing film, one surface of which has a sealable layer and the other surface of which has, where appropriate, a release layer, characterized in that at least the backing film has monoaxial orientation and is composed of a biodegradable aliphatic polyester and/or copolyester.

Surprisingly, it has been found that, among the numerous biodegradable materials which have hitherto been processed to give films, it is the backing films used according to the invention which can meet the high mechanical requirements placed upon a tear-off strip.

Among the biodegradable aliphatic polyesters or copolyesters, it is polyhydroxyalkanoates that are preferably suitable for producing the backing film, such as polyhydroxybutyrates, polyhydroxyvalerates, or mixtures of these, and also polylactides, i.e. polyesters based on lactic acid, and mixtures or copolymers of these. EP-A-0980894 describes the production of these backing films, and also the compositions used for that purpose, and its disclosure is incorporated into the disclosure of the present application.

The backing film preferably has a thickness of from 10 to 200 μm and a width of from 1 to 100 mm. The thickness is preferably from 10 to 40 μm, and the width is preferably from 1.5 to 10 mm, very particularly preferably from 1.5 to 5 mm. The backing film has at least monoaxial longitudinal orientation, the stretching ratio here being at least 1:2, preferably at least 1:2.5. The backing film may also have biaxial orientation, preferably with the stretching ratio given.

The sealable layer is preferably a layer of self-adhesive biodegradable pressure-sensitive adhesives obtained from naturally occurring binders made from vegetable or animal products, preferably from proteins and carbohydrates, e.g. from casein.

The thickness of the sealable layer based on these adhesives is preferably from 3 to 25 μm, particularly preferably from 4 to 10 μm.

It is also possible to use heat-activatable adhesives based on biodegradable, aliphatic oligoesters, such as oligolactides, oligoglycolides, or oligohydroxy-alkanoates.

As an alternative, the tear-off strips of the invention may be provided with biodegradable sealable layers based on heat-activatable, i.e. low-temperature-sealable, biodegradable aliphatic polyesteramides, as marketed by Bayer AG in the form of product BAK (404-004).

Another preferred sealable-layer material is what is known as biodegradable hot-melt, which is based on low-temperature-melting, where appropriate plasticized, biodegradable resins and polymers, these having heat-activated adhesion.

The thickness of the sealable layers with heat-activatable adhesion is preferably from 1 to 100 μm, particularly preferably from 5 to 20 μm.

The sealable layer may be applied in various ways to the backing film, e.g. by coating of adhesive onto the previously oriented backing film, or by coextrusion of the backing film and the sealable layer with subsequent orientation.

The release layer present where appropriate and needed when self-adhesive sealable layers are present is preferably composed of a UV-crosslinked silicone layer. However, thermally crosslinkable silicones or solvent-based silicone dispersions may also be applied. The silicone layers are usually non-biodegradable. However, since their thicknesses are only very small, i.e. below 1μ, they break down into microscopically minute particles once the other constituents of the tear-off strip of the invention have biodegraded. These silicone layers, preferably based on silicone acrylates, are chemically inert and biologically inactive. However, if the polymeric compound is hydrolyzed, the hydrolysis products are degraded microbiologically to give carbon dioxide and inorganic silicates.

The biodegradable tear-off strips of the invention are produced by the usual processes. The silicone layer and the adhesive layer may also, inter alia, be applied using commercially available coating machinery. The subsequent finishing by slitting and reeling uses commercially available roll-slitting machinery and reeler units.

The tear-off strips of the invention may also have been printed. For this, the backing film is printed in one or more operations, and the sealable layer made from, for example, an adhesive which melts at elevated temperatures, is applied to the printing ink. A release coating is then also applied to the other surface of the backing film, to prevent blocking of the tear-off strips. After the layers have been applied, the film webs are slit to the width of the tear-off strips, and preferably reeled in various running lengths.

The printing of the backing film may take place using one or more colors. It may use any of the printing processes which can be used for films. In particular, the printing process uses typical processes for printing packaging, e.g. offset printing, screen printing, flexographic printing, UV flexographic printing, or intaglio printing.

Biodegradable printing inks are used for the printing process. The printing inks here may be based on binders such as nitrocellulose, for example. Many of the color pigments present in the material are likewise based on naturally occurring materials and can therefore be regarded as biodegradable. The same applies to fillers such as carbon black, calcium oxide, or calcium carbonate.

Biodegradable printing inks are available for purchase. Since many naturally occurring pigments have sufficient thermal stability to remain undamaged at the comparatively high temperatures rising during the production of the backing film, it is also possible to color the backing film.

The invention also provides a packaging material which comprises the biodegradable tear-off strips of the invention made from biodegradable material.

According to the invention, the combination of biodegradable raw materials permitted provision of a biodegradable tear-off strip. Surprisingly, it has been found that the mechanical properties resulting from the inventive combination of the biodegradable materials are so excellent as to ensure the functioning of a tear-off strip.

The present invention also provides biodegradable packaging equipped with the tear-off strips of the invention.

### EXAMPLES

Test Methods

The relevant properties of the specimens of tear-off strips of the invention were measured as followed:

The mechanical properties of the backing film or of the final tear-off strip were determined by a tensile test to DIN EN ISO 527 (DIN 53455), DIN 53363, and DIN 53457, and the thickness of the film was determined to DIN 53370.

The release value for the release layer and the residual adhesive forces were determined to FINAT 10 and 11.

To determine the adhesion of the pressure-sensitive adhesive of the sealable layer, low-pressure seal strength was determined. This is the force required to separate a seal seam produced under defined conditions (pressure, temperature, time). It is stated in N, and the width of the strip is added as index (N/15 mm).

Two defect-free sections were taken from the film web to be tested, and their areas to be sealed were placed one on top of the other on the operating table of the sealing device, and held by swinging the weights down into position. In order to provide a constant sealing pressure, care was taken that the film specimen protruded on all sides from below the weights. Sealing took place perpendicularly to the direction of running of the film.

The following standard conditions were used for the seal strength test: pressure 0.35 N/cm², time 0.5 sec, temperature dependent on film type.

A test strip cutter was used to cut a test strip of width 15 mm from the center of the seal seam produced, precisely in the direction of running of the film. A tensile strength testing machine was used to study the seal strength of the test strip, by separating it perpendicularly to the seal seam. The value stated, read off with a precision of 2%, is the maximum force occurring during the tearing of the material.

The processing performance of the tear-off strips produced was assessed on packaging machinery.

Biodegradability is determined to DIN 54900.

### Example 1

A monoaxially longitudinally stretched film made from polylactide with a thickness of 35 μm and an ultimate tensile strength of 160 N/15 mm to DIN 53455 and a tensile strain at break of >10%, and a modulus of elasticity of 3.6 GPa was given a layer of silicone acrylate. The solvent-free silicone acrylate comprised a polymeric photoinitiator, and was crosslinked by UV radiation, using a free-radical system, under an inert gas atmosphere. The release value determined was 0.1 N.

A biodegradable pressure-sensitive hot-melt adhesive based on casein was applied to the other surface of the backing layer. The amount applied was 9.5 g/m². The adhesion was determined as 2.1 N/15 mm.

The resultant film was slit to give strips of width 2 mm, and reeled onto reels of 6 000 linear meters.

The biodegradable tear-off strips of the invention could be processed smoothly on commercially available packaging machinery with a cycle frequency of 200 packages per minute.

### Example 2

A biodegradable hot-melt adhesive was applied to a monoaxially longitudinally stretched film made from polyhydroxybutyrate, the film thickness being 40 μm. The resultant film was slit to give tear-off strips of width 2 mm, and reeled onto reels of 6 000 linear meters.

The tear-off strips of the invention can be used without difficulty on high-speed cigarette-packaging machinery.

What is claimed is:

1. A biodegradable tear-off strip made from a backing film, one surface of which has a sealable layer and the other surface of which has, where appropriate, a release layer, characterized in that at least the backing film has monoaxial orientation and is composed of a biodegradable aliphatic polyester and/or copolyester.

2. The tear-off strip as claimed in claim 1, characterized in that the aliphatic polyester used comprised biodegradable polyhydroxyalkanoates, polylactides, and/or copolymers of these.

3. The tear-off strip as claimed in claim 1 or 2, characterized in that the aliphatic polyesters used comprised a biodegradable polyhydroxy-butyrate, polyhydroxyvalerate, copolyesters of these, a polylactide, and/or a mixture of these.

4. The tear-off strip as claimed in any of claims 1 to 3, characterized in that the sealable layer is composed of biodegradable, preferably self-adhesive or heat-activatable adhesives made from naturally occurring or synthetic material.

5. The tear-off strip as claimed in claim 4, characterized in that the adhesive was obtained from vegetable or animal products.

6. The tear-off strip as claimed in claim 4, characterized in that the adhesive is composed of a biodegradable aliphatic oligoester, preferably of an oligolactide, oligoglycolide, or oligo-hydroxyalkanoate, of a mixture of these, or of a low-temperature-sealable, biodegradable, aliphatic polyesteramide, or of hot-melt.

7. The tear-off strip as claimed in any of claims 1 to 6, characterized in that it has a release layer which is preferably composed of a UV-crosslinked silicone coating.

8. The tear-off strip as claimed in any of claims 1 to 7, characterized in that the backing film has prints made from biodegradable printing inks, or has been colored with biodegradable pigments or dyes.

9. A reel onto which tear-off strips as claimed in any of claims 1 to 8 have been reeled.

10. A packaging material made from a biodegradable material provided with a tear-off strip as claimed in any of claims 1 to 8.

11. A biodegradable packaging with a tear-off strip as claimed in any of claims 1 to 8.
